(19) United States
(12) Patent Application Publication
(10) Pub. No.: US 2023/0297886 A1
(43) Pub. Date: Sep. 21, 2023

(54) CLUSTER TARGETING FOR USE IN MACHINE LEARNING

(71) Applicant: Grabango Co., Berkeley, CA (US)

(72) Inventor: William Glaser, Berkeley, CA (US)

(21) Appl. No.: 18/059,787

(22) Filed: Nov. 29, 2022

Related U.S. Application Data
(60) Provisional application No. 63/283,954, filed on Nov. 29, 2021.

(51) Int. Cl. G06N 20/00

(52) U.S. Cl. CPC G06N 20/00

(57) ABSTRACT

A system and method for training, using a supervised learning process, a first learning model with a first dataset; applying the first learning model to a second dataset thereby generating a first learning model output; training, using an unsupervised learning process, a second learning model with the first learning model output thereby generating a clustering output of the second learning model; determining a bias assessment based on the clustering output; and training, using a third dataset, a bias assessment modified learning model using supervised learning.

### CROSS-REFERENCE TO RELATED APPLICATIONS

This Application claims the benefit of U.S. Provisional Application No. 63/283,954, filed on 29 Nov. 2021 which is incorporated in its entirety by this reference.

### TECHNICAL FIELD

This invention relates generally to the field of machine learning, and more specifically to a new and useful system and method for cluster targeting for use in machine learning.

### BACKGROUND OF THE INVENTION

Machine learning algorithms build a model based on sample data in order to make precisions or decisions, in order to accomplish tasks, without being explicitly programmed to do so. This involves computers learning from training data. Collecting, cleaning, and preparing a training dataset can be expensive and slow. In many cases, more training data can result in better machine learning models. However, as the training data grows larger, there is less visibility into the nature of that data. As a result, despite perhaps having high performance for certain tasks, machine learning models can result in critical errors. For example, lack of proper representation of less common situations can lead to mislabeling of those instances. Or when using data obtained from the open web, labels may be learned that are undesirable or potentially hurtful.

In many cases, when such issues become apparent, a slow and expensive process is required to clean data and retrain a model. Even still, edge cases can always emerge and so such a data cleaning process may be an ongoing endeavor.

In the modern era, data is all around us, but clean datasets are expensive to produce and rare to possess. Moreover, it's incredibly difficult to know how clean large datasets really are, or what patterns lie within them that one would not want to amplify with the machine learning mode. Thus, there is a need in the machine learning field to create a new and useful system and method to resolve such problems. This invention provides such a new and useful system and method.

### BRIEF DESCRIPTION OF DRAWINGS

FIG. 1 is a flowchart representation of a first method variation.

FIG. 2 is a flowchart representation of a second method variation.

FIG. 3 is an exemplary flowchart representation of a method variation using iterative enhancement of a learning model.

FIG. 4, is an exemplary flowchart representation of a method variation showing use of data and learning models.

FIG. 5 is an exemplary schematic representation of cluster improvement in a learning model.

FIG. 6 is a screenshot representation of an exemplary user interface used for inspecting a cluster.

FIG. 7 is a schematic representation of a system variation.

FIG. 8 is an exemplary system architecture that may be used in implementing the system and/or method.

### DETAILED DESCRIPTION OF THE EMBODIMENTS

The following description of the embodiments of the invention is not intended to limit the invention to these embodiments but rather to enable a person skilled in the art to make and use this invention.

### 1. Overview

A system and method for cluster targeting for machine learning training functions to use unsupervised learning model to inspect a supervised machine learning model and optionally inject of subjective taste to guide supervised learning with diverse datasets.

The system and method may use unsupervised learning techniques to cluster, categorize, label, and/or otherwise organize data processed by a first model (e.g., a supervised learning model). The system and method may use those clusters to evaluate the model and possibly augment training of a subsequent learning model. This may result in a usable learning model with better performance than the initial first model. Such a system and method may be iteratively used in the refinement of a machine learning model.

The system and method is preferably used for the inspection and/or improvement of a primary machine learning model or system. The primary machine learning model or system in one variation is a supervised learning model that is generated using a set of training data. More generally, the primary learning model may be any suitable learning system or collection of learning models, data analysis processes, or other processes that is trained and used to generate an output for a given input data sample. Machine learning models traditionally generated without the method and system may include undesired biases, poorly trained edge cases, and/or other issues, which the system and method may assist in detecting and/or resolving.

In some variations, the system and method can be used in automating the identification and detection of different output scenarios of a machine learning model including various edge cases. In some variations, the system and method may further support refining the existing training data, by adding additional training data, altering the training process of a learning model, and/or performing other changes to address issues determined through analysis of the clusters from the unsupervised learning model. This can enable agents (automated or otherwise) to inject subjective judgement of performance of a machine learning model on such scenarios. For example, a computer vision classification model may have classification of images including wheelchairs be clustered through the unsupervised learning model. How these images are handled by the supervised learning model may be better inspected for these wheelchair related images, and then used to improve the supervised learning model.

Such a system and method may be implemented in stages of learning, and/or iteratively incorporated as part of the refinement of a primary machine learning model (e.g., a supervised learning model or system). The system and method functions to enable unique creation of an enhanced learning model, through incorporation of stages of both supervised and unsupervised, training/teaching the enhanced learning model to takes into account biases, subjective or otherwise, in the learning model. These biases may comprise model accrued biases, through the initial learning stage learning model, and/or user incorporated biases.

The system and method may be implemented for any general computer/AI learning implementation. Examples include image processing (e.g., object detection, object classification/identification, navigation/tracking, image-based event detection, image/image synthesis/generation, and the like), audio processing (e.g., sound classification, sound transcription, automated audio generation), natural language processing (e.g., text labeling, test summarization, text synthesis), digital bots, sensor data analysis, analysis of other parametric data (e.g., web or app analytics, financial data, business data), and/or other applications. The system and method may be particularly useful for implementations that include learning models with extremely large or open datasets for learning. The system and method may be uniquely able to inject bias, counteract existing bias, and/or refine the performance of the primary learning model/system. Herein, examples related to computer vision and image/video data analysis using machine learning and neural networks are used as examples. However, the systems and methods may be used in other fields of machine learning such as raw data interpretation, natural language processing, and/or other applications.

The system and method, in some variations, may be used for inspecting and interpreting a machine learning model. In some variations, the system and method may use unsupervised learning model to organize or cluster a dataset to better understand the base learning model. In one exemplary variation, the system may generate sampling from such clusters and presenting this sampling in a review interface. In some variations, this may include transmitting such data samples (or representations of data samples) to a review interface and receiving accuracy input. This input may be used in mapping or interpreting the base learning model and/or for updating the learning model accordingly.

In some variations, inspection may be accompanied with automated analysis within clusters, the learning model, and associated dataset(s).

In cases where a machine learning model/system is trained using a vast amount of data, especially when the data is obtained from the open-web or expected to include errors and problems, the system and method may provide a useful tool for inspecting the machine learning model/system. For example, administrators may be able to review different scenarios and more readily understand where the machine learning model/system excels (robustly trained, with accurate results), and/or scenarios where the model is weaker, wrong, or perhaps subjectively has an undesired result (e.g., exhibiting discriminatory behavior). Such inspection and interpretation may be presented in a unique form of user interface to enable users to explore with a greatly enhanced ease.

In one such variation, inspection and analysis might be done by the very learning model system that was trained by the data. Inconsistencies within any given cluster may indicate a need for more targeted training. The model may then sift through large quantities of unlabeled data in order to find examples that would become a part of the problematic cluster. Those examples can then be labeled (e.g., by a human or automated system) and used as future training data.

The system and method, in some variations, may further use a resulting interpretation of a machine learning model/system to then enable improvements to the machine learning model/system. This may involve automating or facilitating modifications to training data or otherwise altering the training of an updated machine learning model/system.

In one example, if a particular cluster is entirely made up of false positives, then those examples can be relabeled as such and used in subsequent trainings. Moreover, a small problematic cluster (false positives or false negatives) can be used to train yet another model to comb through unlabeled data in search of candidates for labeling. In this way, a small labeled dataset may be used to identify infrequently occurring problems in need of attention, go out and find additional examples, and concentrate them for labeling (automatically or with a human checker) to improve subsequent training of the main model.

In another exemplary application, the system and method may be used in gathering new and improved training data. For example, when a cluster of results are identified that have poor Receiver Operating Characteristics (ROC), more training data can be generated to target areas needing improvement. A machine learning model may include clusters that are well-trained while others that are poorly-trained. The system and method may be used to first learn what clusters need better training, and then to find the specific examples to use to improve the training for those cases. The system and method's cluster-targeting approach to data curation, gathering, and/or generation may allow one to be more precise in characterizing weaknesses in the system and then finding the training-data to remedy them.

The system and method may be used to take advantage of the insight that the system-level AUC (area under the receiver operating curve) is a weighted average of the cluster-level AUCs that make up the test data. Targeting the worst-performing clusters for improvement is likely to improve the system-level performance, and remedy edge case problems, better than simply adding more bulk data that is untargeted to a known need.

In another exemplary application, the system and method may facilitate generation of synthetic data samples that may be used. AI-based image, audio, or text generators or other processes to synthesize new data samples may be used. They can be use data samples from a cluster as a template or base representation of data samples, from which new evolutions and computer-implemented “imagining” of new samples may be produced and used as training data.

In another exemplary application, the system and method may use upsampling, sample weighting, or other techniques to influence the retraining of a base learning model to address detected issues in select clusters.

The system and method may provide a number of potential benefits. The system and method are not limited to always providing such benefits and are presented only as exemplary representations for how the system and method may be put to use. The list of benefits is not intended to be exhaustive and other benefits may additionally or alternatively exist.

The system and method may provide the potential benefit of automated detection and inspection of machine learning output results. Through the incorporation of unsupervised learning, machine learning output of an initial model or system may be automatically gathered and clustered to identify learning patterns and biases. Additionally, such inspection of a learning model may be more efficient as the system and method can organize data and extract information for better review and response.

In the same manner, the system and methods' use of unsupervised learning may provide the potential benefit of early detection and evaluation of edge cases in the output results of machine learning models, such as neural networks. An administrator may use a user interface provided through the system and method to inspect and identify scenarios where the results may not be acceptable or ideal.

Additionally, the system and method may provide the potential benefit of enabling the incorporation of subjective interpretation into the data. Through multi-stage learning, learning trends may be identified, which can then be used to augment training data and/or the training process to provide (or alter) subjective interpretations in the constructed learning model.

Through the incorporation of a subjective interpretation, the system and method may enable a greater level of ethics in the actions of the machine learning model. As the behavior of an AI may be limited by the dataset that the AI was trained on, a subjective interpretation may be used to train/modify the AI behavior beyond the original dataset. In this manner, the system and method provide the potential benefit of and AI with a higher levels ethics (for example, by removing/reducing racial biases that were accidentally incorporated into the AI).

The system and method may provide a more efficient way of machine learning. With current technologies, machine learning algorithms generally train quite well to some level of learning, where beyond that level of learning, ad hoc methods are incorporated to fix higher level mistakes. The system and method provide the benefit of a more efficient/directed approach to fixing the higher level mistakes by identifying mistakes as biases and focusing training on those biases.

The system and method, in some variations, may enable feedback from a deployed implementation of a machine learning model/system to more efficiently enhance the machine learning model/system. When deployed, unique situations may arise that were not captured or poorly represented in the training data of a base learning model/system. Such user feedback systems may be more deeply integrated into machine learning development. For example, a machine learning service may offer a way for users to flag results (e.g., flagging as problematic or wrong), the related data samples can then be mapped to a cluster using the unsupervised learning model, which may then be used to augment a new version of a learning model/system. An administrator could see a flagged issue or issues and possibly see if related data samples have undesired biases in the training data, trained incorrectly, have low coverage in training data, and/or other issues.

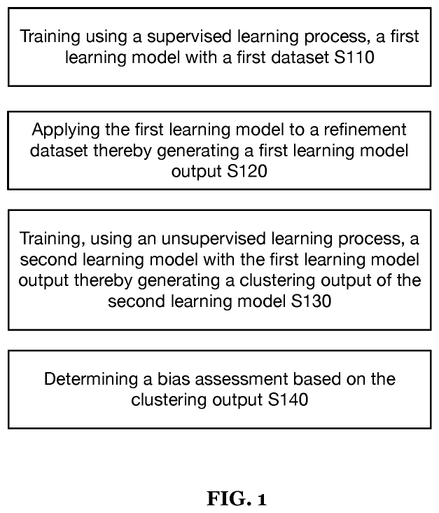

As shown in FIG. 1, a method for cluster targeting for use in machine learning can include: training, using a supervised learning process, a first learning model with a first dataset S110; applying the first learning model to a second dataset thereby generating a first learning model output S120; training, using an unsupervised learning process, a second learning model with the first learning model output thereby generating a clustering output of the second learning model S130; and determining a bias assessment based on the clustering output S140.

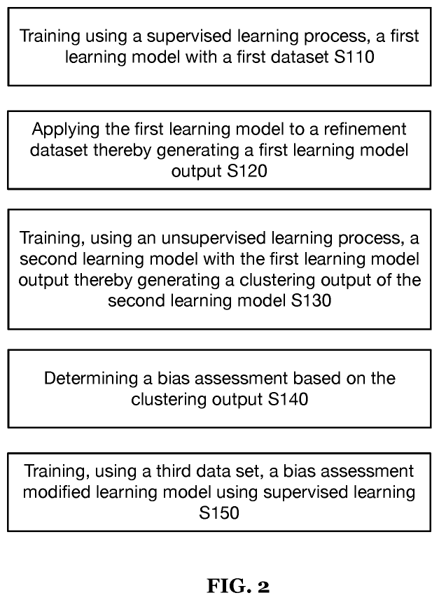

In some variations, the method is used in producing enhanced learning models. These enhanced learning models may be enhanced by resolving issues of an initial model, possibly even injecting subjective interpretation of different scenarios. Accordingly, in some variations, the method may include training, using a supervised learning process, a first learning model with a first dataset S110; applying the first learning model to a second dataset thereby generating a first learning model output S120; training, using an unsupervised learning process, a second learning model with the first learning model output thereby generating a clustering output of the second learning model S130; determining a bias assessment based on the clustering output S140; and training, using a third dataset, a bias assessment modified learning model using supervised learning S150 as shown in FIG. 2. The third dataset may be a dataset that may be based on the first dataset, modified based on the bias assessment. Modifications based on the bias assessment may include adjustments to amplify data samples poorly represented, add data samples, added select data samples to supplement categories of data with poor representation, add synthesized data samples, and/or modified in other ways. In practice, an automated process and/or user input may be used to detect subsets of data samples that may be useful in resolving issues with the first learning model (i.e., the supervised learning model). This may be used to inject subjective preference in the treatment of different scenarios. For example, it may be discovered that computer vision detected events (using a learning model trained from labeled data) accurately detects a product pickup event when customers pick up products from a shelf (e.g., a true positive event), but falsely detects the customers grabbing a shopping cart as a product pickup event (e.g., false positive event). In this example, the method may be used to first detect this cluster of data samples with common false positive events and then augment the training data so that a resulting updated computer vision learning model (e.g., an updated supervised learning model) more accurately interprets data where a customer is grabbing a shopping cart.

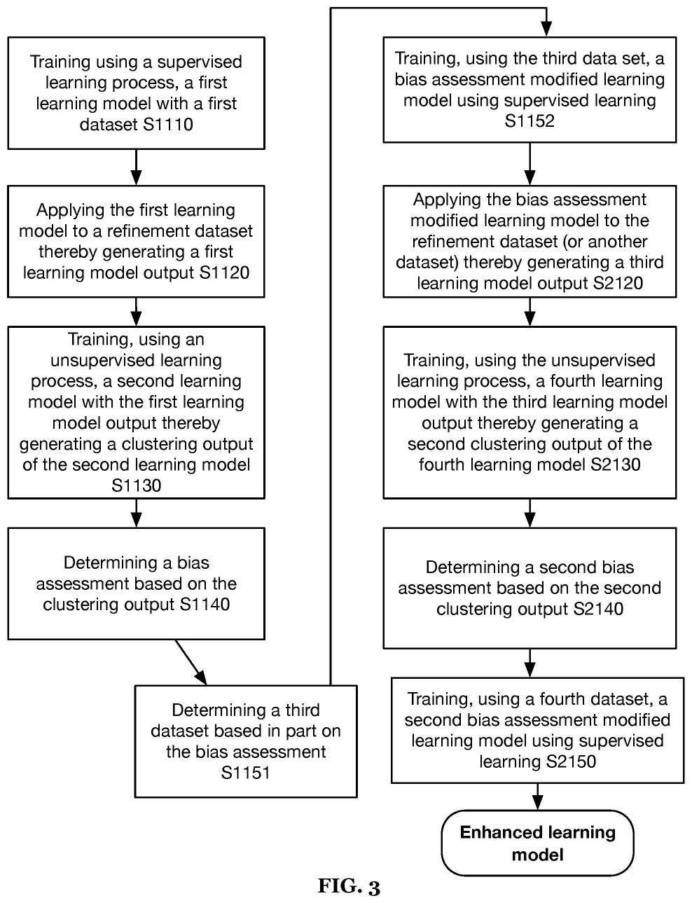

As shown in FIG. 3, the method may be used by iteratively improving a learning model whereby the method is used to improve a resulting learning model with each iteration. Accordingly, the method may include: training using a supervised learning process, a first learning model with a first dataset S110; applying the first learning model to a second dataset thereby generating a first learning model output S1120; training, using an unsupervised learning process, a second learning model with the first learning model output thereby generating a clustering output of the second learning model S1130; determining a bias assessment based on the clustering output S1140; determining a third dataset based in part on the bias assessment S1151 (e.g., the first dataset augmented with supplemental samples); training, using the third dataset, a bias assessment modified learning model using supervised learning S1152; applying the bias assessment modified learning model to the second dataset (or another dataset such as subsequently acquired data) thereby generating a third learning model output S2120; training, using the unsupervised learning process, a fourth learning model with the third learning model output thereby generating a second clustering output of the fourth learning model S2130; determining a second bias assessment based on the second clustering output S2140; and training, using a fourth dataset, a second bias assessment modified learning model using supervised learning S2150.

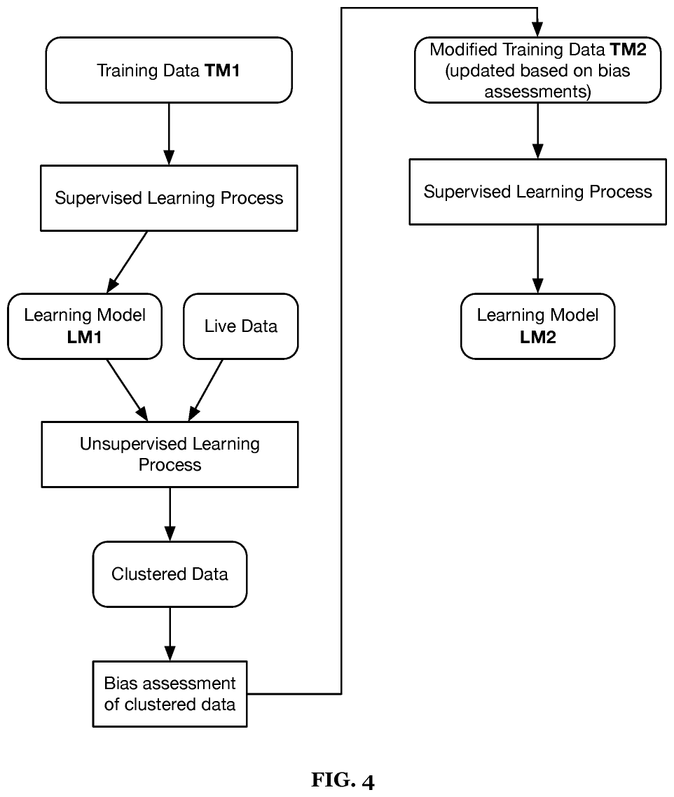

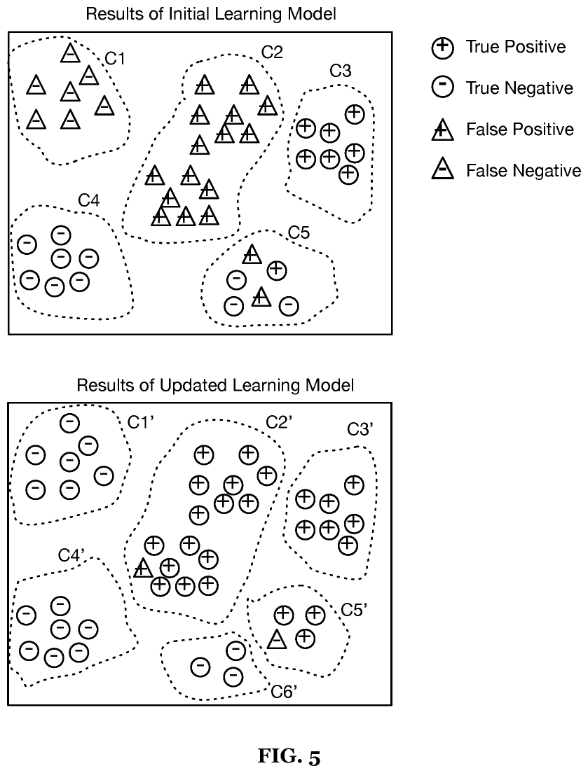

Iterative processing using the model may be used to update the training of a supervised learning model. As shown in FIG. 4, with appropriate modifications to training data, an initial learning model LM2 may improve upon the results of an initial learning model LM1 by updating, supplementing, or otherwise augmenting training data TM1 to use the modified training data TM2. This enhancement process may be repeated any number of times by applying processes S130, S140, and S150 for further iterations of the process. As shown in illustrative FIG. 5, this may be used to improve the performance of the learning model to better interpret data such that there are fewer false positives and false negatives. In this example, initially, clusters C1 and C2 have many false negatives and false positive results and so are anti-trained, C3 and c4 have accurate results, and C5 has mixed results. With cluster-based adjustments C1′ and C2′ are shown to have improved performance, C3′ and C4′ maintained good performance, then C5′ saw improved performance, and new cluster C6′ was introduced with also better performance.

In some variations, the method may use an automated or semi-automated processes for resolving issues with an initial supervised learning model. In some method variations, determining a bias assessment based on the clustering output includes automatically determining a problematic clusters where the first model output matches an undesired condition. Automatically determining a problematic cluster may involve detecting an inconsistency in the results within a cluster. For example, if a cluster has results with a mix of output results from the supervised learning model, then that can indicate that the supervised learning model is not adequately distinguishing between those events. More data within that cluster may benefit an updated supervised learning model.

In some cases, manual review may flag or annotate individual data samples as having an issue. Then an automated process can use this sample data annotations in automatically determining when clusters may satisfy an undesired condition. An undesired condition may be triggered when the instances of flagged data samples within a cluster satisfies some condition such as reaching some threshold of number of occurrences, some percentages of samples within the cluster, occurring at or greater than some frequency. Flagged data samples would be flagged as a result of some output of the supervised learning model potentially having a false positive or false negative result.

Automated processes may use the consistency and results trends within a cluster to determine training data augmentation recommendations for each cluster. Each cluster may be analyzed for trends in being a cluster matching a true positive cluster, true negative cluster, false positive cluster, false negative cluster, or a mixed result cluster, or inconclusive cluster (having low confidence results). True positive clusters and true negative clusters presumably do not require additional sample data. False positive clusters, false negative clusters, mixed result clusters, and/or inconclusive clusters may have recommendations for additional sample data or receive other training data augmentations when training an updated supervised learning model.

The method may additionally use automated processes for augmenting training data for an updated learning model trained through block S150. In some variations, the method may include synthesizing data samples based on samples of the problematic cluster. This can include using diffusion models, GANs (Generative Adversarial Networks), or other approaches to generating variations or more sample data.

In other variations, a cluster may be flagged using an automated alert, requesting additional data for training. When automating this process of collecting data to augment the training data for a supervised learning model, the method may include various user interface features. In one variation, the method may include collecting supplemental data sample for the problematic cluster, and verifying the supplemental data sample is matched to the problematic cluster using the second learning model. Additionally, the method may automatically set a target number of additional samples for collection and present a progress indicator based on the number of samples collected that match the problematic cluster. For example, if the problematic cluster involves users with wheelchairs then a user may need to upload more sample data. A progress bar will progress towards a completion state as additional sample data is added that is classified within the same cluster (according to the unsupervised learning model).

In some variations, the method may be used to appropriately address clusters according to the results within a cluster and/or the associated training data related to the cluster.

For clusters of true positive or true negatives, the base learning model may be determined to be well trained within this cluster as they generate appropriate outputs for a samples within the cluster. The method may additionally verify that the associated training data associated with this cluster also meets conditions to qualify as a well trained cluster. For example, the method may ensure that a sufficient number or percentage of samples are represented in the training data. In some cases, a cluster may be assigned some priority (e.g., corresponding to the importance of correctly modeling this cluster in a particular business application) and this may alter evaluation of the cluster.

For clusters with false positives or false negatives, the base learning model may be anti-trained within this cluster as it generates the wrong results. Labels may be corrected and/or more examples collected to retrain and improve performance within such a cluster.

For clusters that include a blend of true and false results, the model may be insufficiently trained on scenarios of these clusters. Improved labeling and/or adjustments to the training data may be used. If more data is not available, use these cases to train a side model to find more examples.

In some variations, the method may receive and use external input such as from an administrator or another system. In such variation, determining a bias assessment based on the clustering output S140 may include receiving, through an interface, bias assessments for a first cluster. The interface may be a user interface, through which, for example, a user may be able to review and inspect clusters and/or individual samples/results and then apply some bias assessment for a cluster and/or a sample/result. Input may be collected for a plurality of clusters. In particular, poorly performing clusters receive input, but well performing clusters may similarly be noted through user input.

In one such variation, the method may additionally include processes for facilitating such collection by presenting a specialized user interface generated from automated interpretation of the data. In such a variation, the method may include presenting a user interface with representative examples from at least one cluster. Then the method may include receiving a bias assessment input for the at least one cluster. This input may indicate if the cluster or a sample in the cluster is accurate or inaccurate.

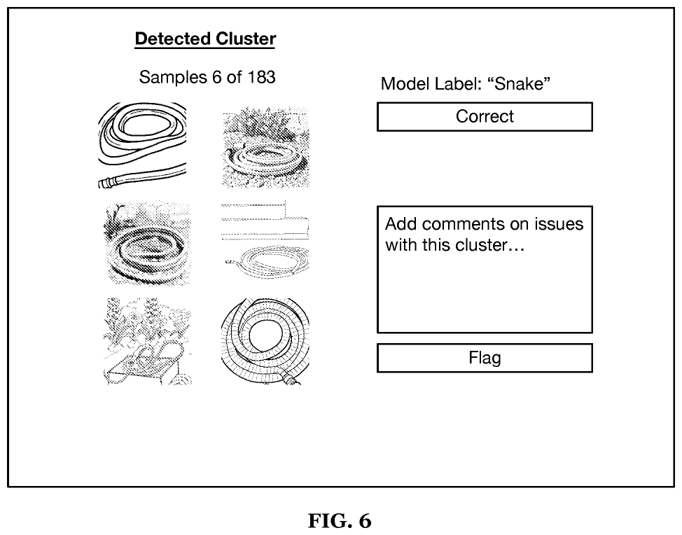

A presented interface may be presented to enable user navigation and inspection of clusters. A user could review clusters and then annotate results to flag issues or provide input out expected/desired outcomes. Such manual review may be used to inject subjective taste into training of a supervised learning model. The user interface may present information in a variety of ways. In one version, a spatial map of clusters and sample data may be presented where spatial positioning of samples reflects commonality in the sample data. In another version, the system may automatically segment samples into clusters and present these as a group of samples. As in the exemplary interface shown in FIG. 6, a cluster may be inspected where a number of representative image data samples are shown. The user can quickly see the conclusions of the supervised learning model within this cluster as being “snake”. Knowing that these images are actually images of hoses, the user may flag this cluster as having an issue and further add the note that these images should be classified as “hose”. In subsequent training of the supervised learning model, more labeled images of hoses may be useful. In some cases, the testing data used by the unsupervised learning model may also even be selectively used, especially when the testing data comes from live data where the supervised learning model may be used.

In some exemplary implementations, problematic clusters may be prioritized for review by a user. Problematic clusters may satisfy some undesired condition, have correspond to a low number of corresponding training data samples, or other issues. For example, after clustering the second set of data, the unsupervised learning model may also analyze the training data and map the training data to resulting clusters and determine if individual clusters map to satisfactory training data conditions (e.g., sufficient diversity of samples, number of samples, etc.). The user interface may alternatively allow a user to review all clusters. User input may also be used to confirm that a cluster is being accurately processes.

While the user interface may be used in combination with a method that includes block S150, the method may also be used in generating a unique representation of a learning model that can be useful for inspection and interpretation of a learning model.

In some variations, the method may use a mix of automatic and user-assisted processes in determining bias assessments. These may be used in synthesizing new data within a cluster, amplifying data, selecting data of a cluster from the second dataset (e.g., the testing or live data) for use in the training data, generating a task or alert for supplying of exemplary data related to a cluster (and possibly uploading data, using unsupervised model to validate the data is within a cluster, and then adding the data to the training data), and/or performing other processes for improving performance.

The method may be used in a variety of machine learning applications such as in the production of learning models used for working with a variety of media types such as images, video, audio, sensor data, various types of parametric data (e.g., financial transaction data, app/website usage data, medical data, etc.) and/or other arbitrary data types or a mix of data types. In one example, the method may be used in refining a learning model used for interpretation of image data (e.g., still images or video images). In some instances, this model may be used to detect particular events. The method may be used to train a learning model for detecting products, identifying products, detecting interaction events (e.g., product pickup events), or other computer vision tasks when used with a computer vision monitoring system used for applications mentioned in U.S. Pat. No. 10,339,595, issued 2 Jul. 2019, which is hereby incorporated in its entirety by this reference.

In one example, the first dataset and the second dataset include image data. The method may include training a supervised learning computer vision model with a training set of data (e.g., labeled image data) (S110); applying the supervised learning CV model to second set of image data, thereby generating output of the supervised learning CV model (S120); training an unsupervised learning model with the output thereby generating a clustering of the second set of image data (S130); and determining a bias assessment for at least one cluster in the clustering of the second set of image data (S140); and optionally training an updated supervised learning CV model with an updated training set of data (S150), wherein the updated training set of data is generated based on the bias assessment of the at least one cluster.

The method may be performed using a collection of different sets of data. A first dataset may be labeled data that is collected and prepared for use with a supervised learning model. Such datasets may be large datasets that can be costly to collect and prepare. A second dataset may used in connection with eventually performing unsupervised learning.

The second dataset may be a selection of data used for testing the results. In some cases, the labels of the second set of data may be known, and so it can be used to determine if the results of the supervised learning model is yielding true positives, true negatives, false positives, false negatives, or mixture of results within a cluster.

In other variations, the second dataset may be live data, where the supervised learning model is being used in the wild with data for some application. Warnings, errors, and/or other issues that are noted while using the supervised learning model may be used to interpret data clusters from an unsupervised learning model.

In yet another variation, the training data may be run through the unsupervised learning model. While many ML approaches attempt to avoid such use of training data. In some variations, such an approach may be used with the method for improved performance, while avoiding the issues commonly encountered. For example, the training data may include errors, and using all or a subset of the training data (the first dataset) as the second dataset may enable errors, inaccuracies, and/or other biases to be identified in the clustering and then resolved. Issues in the labels of the training data detected through S120, S130, and S140, may be used to correct labeling for subsequent retraining of the supervised learning model.

Such an approach may be used when a training dataset is large and known to be imperfectly labeled, the method may cluster that source data for inspection. When one can't afford to inspect every label for correctness in a very large dataset, a user or automated system can reasonably inspect representative samples from each of a handful of clusters. If one or more clusters of training data looks inconsistent, it can be relabeled, or possibly just removed from the dataset.

This inspection might be done by a user through a user interface of the method. In that case, user input may be collected for enough samples from each cluster to get a sense for what they represent and how good their AUC is. They then go about finding more training data to augment the clusters with poor AUCs.

Alternatively, this inspection might be done in an automated fashion using a system that was trained by this data. Inconsistencies within any given cluster indicates a need for more targeted training. The model can then sift through large quantities of unlabeled data in order to find examples that would become a part of the problematic cluster. Those examples can then be human labeled and used as future training data.

The method comprises stages of supervised and unsupervised learning, that together addresses and/or incorporates biases in the machine learning process. That is, the method provides a process that enables understanding how a machine is being trained and provides tools for if and how the training can be corrected. The performance of a trained machine learning model can be evaluated and assed using unsupervised learning (or using other segmentation or classification techniques), and then (optionally) a refined machine learning model can be generated based on such bias assessments (e.g., by collecting supplemental training data, augmenting labeling of data, etc.). The method may be implemented as an iterative process, where stages of supervised and unsupervised learning may be cycled through to identify and ‘improve’ the machine response to biases with respect to some task to be learned. The method may be implemented as part of any generalized machine learning model, such as artificial neural networks (ANN), support vector machines (SVM), Bayesian networks, or genetic algorithms (GA).

The method may be implemented to train a machine for any general, or specific, task where the machine includes the necessary components to accomplish that task. For example, a machine comprising a processor may be taught to detect and classify objects (e.g., products in a store), detect or classify events (e.g., user-item interaction events), and/or perform other operations in digital image data. In another example, a machine comprising processor, a microphone, and a loudspeaker may be taught to classify or analyze image data, audio data, sensor data, digital data, and/or other forms of data. Generally, the method may function with any system comprising a processor, memory storage, and any required additional components necessary for the task to be learned.

As used herein, bias refers to any general trends in the learning model(s). For example, an AI training/trained to identify people in a store may have a bias (weakness) to identify people in wheelchairs as people. Detection of such a bias can be formed as a bias assessment resulting from the unsupervised learning, and then that bias assessment can be used to correct for any unintentional misclassification by a machine learning model. In this way, bias assessments may be used to inject subjective judgement into training of a machine learning model. For simplicity, biases will be referred to as simple concepts related to exemplary scenarios such as undesired misclassification of people in image data. In general, biases comprise any sort of characterization for clusters of data that may, or may not, be identifiable as physical concepts.

In some variations, bias assessments may be used to characterize results of a first learning model as being true positives, true negatives, false positives, false negatives, and/or mixtures of such results. In one example, a bias assessment may be determined for a cluster of sample data that consistently is mischaracterized by the first model as false positives. In another example, a bias assessment may be determined for a second cluster of sample data that includes an number of false positives and true positives, in which case this may indicate that training data representative of this cluster may be used to improve the model.

The method may be implemented to address biases by using results to more accurately use results of a trained model, enforcing/implementing a bias, by fixing/reducing a bias, interpreting/inspecting a model, and/or for other applications. In one variation, biases may not initially exist in the learning model, but the method may be applied to incorporate biases. For example, in this variation the method may be implemented to incorporate or “inject” ethical biases into the machine learning model. In another variation, biases may have been unintentionally learned by the model, and the method may be applied to reduce an undesired bias. For example, the method may directly train on biased assessments to improve/remove weakness of the model (e.g., reduce bias of failure to identify people in wheelchairs as people).

Supervised learning (or supervised machine learning) is a computer-implemented process characterized by use of training data (e.g., a labeled dataset) to train a resulting learning model to classify or interpret input data. This may be used in assigning classifications, detecting events, or predicting outcomes. In general input training data is used to refine the supervised learning model, which may adjust its weights until a resulting model has been fitted and achieves a desired performance level. That is, the first dataset and third dataset include both inputs and the desired outputs of their respective supervised learning models. Examples of supervised learning models include: nearest neighbors, naive Bayes, decision trees, linear regressions, support vector machines, and neural networks. Any suitable type of supervised learning algorithm or set of processes resulting in an processing/ML model may be used.

Unsupervised learning (or unsupervised machine learning), is a computer-implemented process characterized by a process to analyze and organize (e.g., cluster) unlabeled datasets. Unsupervised learning may discover patterns or data groupings without need for human intervention or pre-existing labels. In other words, unsupervised learning may result in a model of data using data inputs and no desired outputs/labels of that data inputs. They are generally used to find patterns and to segment or classify data. The unsupervised learning algorithms can be used in grouping/clustering results from a machine learning model to better understand patterns in the models performance. The unsupervised learning algorithms may use different types of clustering processes resulting in exclusive, overlapping, hierarchical, and/or probabilistic clustering. That is, the set dataset includes just inputs for the associated learning model. Examples of unsupervised learning models include: k-mean clustering and association rules. The unsupervised algorithms may include Any suitable type of unsupervised learning process or alternative classification/segmentation process may be used.

As used herein, incorporated datasets may be real life data and/or events or digital data. That is, incorporated datasets may be real life sets (e.g., videos/pictures of people faces for facial identification), simulated data (e.g., computer generated/drawn pictures of faces for facial identification), or digital data (e.g., event data from an application). Any combination of real life and simulated data may be incorporated. In many variations, available initial datasets may comprise real life data, while simulated may then be incorporated to make up for weaknesses (biases) of the real life data.

Block S110, which includes training a first learning model, using a supervised learning process with a first dataset, functions to generate a base machine learning model. The first learning model may alternatively be referred to as a supervised learning model. Training the first learning model functions as the initial implementation of a machine learning algorithm to “teach” a machine to accomplish a task using supervised learning. Block S110, may incorporate any desired type of supervised learning model which is then applied to the first dataset.

As part of a supervised learning algorithm, the first dataset includes both inputs and desired outputs for the model. In other words, the first dataset is a labeled dataset. The labeled dataset may have been manually labeled data. The labeled dataset may additionally or alternatively include automatically labeled data, such as a dataset pulled from the open internet that automatically associates related labels to data. Data in the first dataset may be either real life data, simulated data, or a combination of both. In some variations, the first dataset may include ground truth data.

Block S110 may include an end sequence (e.g., a marker to designate when the supervised learning should end). This may comprise a certain time period, a number of applied iterations of the first dataset, etc. In many variations, block S110 may have a success threshold to mark its completion prior to initiating other blocks of the method. For example, in one implementation block S110 is set a 90% success threshold (e.g., when the machine can identify faces correctly 90% of them time). Once the threshold has been achieved.

The method may be used with a variety of data types. In one example, the dataset includes labeled image data (e.g., digital images, photographs, 3D images, videos, etc.). The supervised learning model may be used for various computer vision tasks such as object detection, object classification, event detection, and/or other tasks. In another example, the dataset could include audio data (e.g., speech audio, music audio, or other sound audio). In another example, the dataset could include natural language data such as text from transcripts, articles, or documents. The data may also include other types of data or combinations of data types.

Block S120, which includes applying the first learning model to a second dataset thereby generating a first learning model output thereby generating a first learning model output, functions to apply the ‘trained’ model to a set of test data and to record the outcome. In this manner, the second set of data comprises data to test first learning model and to use its output to generate a new dataset. The second set of data may be real data, fixed test data, and/or simulated data.

As non-training data, the second set of data may, or may not, include corresponding desired outputs for each data input. Accordingly, the first learning model output may or may not be accurate results. When the second dataset is test data, the desired label may be known and so a comparison of the first learning model output and the desired output for a given sample may indicate if the first learning model has an accurate outcome (e.g., a true positive or true negative) or an inaccurate outcome (e.g., a false positive or false negative).

As discussed, in some variations, the method may be used directly on the training data and as such the method may not include block S120 and/or second dataset may be the same or a subset of the first dataset.

Block S130, which includes training a second learning model using an unsupervised learning process clustering output of the second learning model, functions to learn/detect the patterns of activity of the first training, whereby these patterns may be separated and identified as correct activity and biases in the model. The clustering resulting from unsupervised learning analysis can include exclusive clustering, overlapping clustering, hierarchical clustering, and/or probabilistic clustering. In an alternative variation, the method may include multidimensional mapping to position samples within some multidimensional arrangement. In this case, there may be no distinct clustering, but the arrangement may signify relationships. For example proximity of samples may indicate their similarity as determined by the unsupervised learning model.

The unsupervised learning can cluster or organize results of the first model into actionable clusters or sub-groups. By learning off the first learning model output, the second learning model may identify patterns in the output that identify biases in the activity of the first learning model. Additionally or alternatively, the unsupervised learning may detect patterns in sample data that are not evident in the labeled training data. The second learning model may generate clustering output(s), i.e., pattern(s), where these clusters may be used to identify trends, and potentially biases, of the first learning model.

The unsupervised learning process may be performed with the second dataset and/or the first learning model output. In general, the second learning model is used to group data samples according to patterns extracted using unsupervised learning. As block S130 may not use human classification, the clusters may be grouped into clusters that make intuitive sense to a human reviewing the samples. In other cases, the clusters may be grouped into clusters that are grouped according to patterns less easily (or perhaps impossible) for a human to observe. Regardless, such patterns may provide insights into performance of the first learning model and offer a pathway for enhancing the performance of a final supervised learning model.

The dataset used (e.g., the refinement data) may pre-date the first training, may include data extracted as important examples from bulk raw data and subsequently tagged, labeled test data, live data, and/or any suitable type of data.

Application of the unsupervised learning model may be used in different ways for clustering or automatically classifying/segmenting/tagging samples. For example, block S130 may vary depending on if the process is used in combination with test data, live data, or training data.

In a variation, where unsupervised learning is used with testing data, data clustering of block S120 may use the combination of samples of the test dataset, the output of the first learning model, and the labeled result of the test dataset. In this way, patterns in the samples (e.g., visual patterns in image test data) and patterns in results (e.g., true positive, true negative, false positive, false negative) may be used in combination to cluster data. For an exemplary object classification supervised learning model, this may cluster a group of snake images correctly labeled as “snake” in a first cluster, but then cluster a second group of images of garden hoses incorrectly labeled as “snake” in a second cluster.

In a variation where unsupervised learning is used with live data, data clustering of block S120 may use the live data directly when clustering data. In some variations, the clustering of live data may use the results from block S120. In some alternative variations, the method may not include S120 or otherwise use the output of the first learning model in block S130 (they outputs may be used in S140 to assist in detecting bias or undesired results). For example, S120 may be performed with the second dataset without any input resulting from the first learning model. This variation may be used while the first learning model is used in the wild with real-world data. As the first learning model is being used in a real-world application, the second dataset may reflect the actual type of data that would be encountered. This may be used to understand scenarios where there is little training data for commonly encountered data.

A variation used with live data may additionally include processing the first dataset with the second learning model and evaluating/scoring clusters based on mapping of training data to clusters. This may be used, for example, to identify clusters where the training data does not satisfy a sample count condition. Each cluster, or at least clusters of significance, will preferably have sufficient samples in the training data so that the cluster can be adequately analyzed. As a result, the training data or a subset of training data may be scored based on coverage of all or a select set of clusters.

In a variation, where unsupervised learning is used with the training data or a subset of the training data, unsupervised learning may be used to automatically group samples based on detected patterns. This could be used in more efficiently reviewing training data and cleaning training data. When the training data is expected to include some number of errors, the clustering may enable efficient review of clusters and resolving the issues. Using the snake and garden hose example, the method may be used to detect that detect that image data labeled as snakes are segmented into two clusters according to the unsupervised learning model, and then determine that one of those clusters actually includes garden hoses or other types of hoses labeled as snakes. This can enable the training data to be cleaned and then reused to train an improved supervised learning model.

Block S140, which includes determining a bias assessment based on the clustering output; functions to interpret performance of the first learning model within one or more cluster. In many variations, this may enable a user and/or automated system to create a desired bias assessment for the first data model.

Dependent on the training of the first learning model, block S140 may be used to identify zero, one, or multiple biases of the first learning model in block S140. A bias assessment can be a data annotation on the results within one or more clusters. Bias assessments may correspond to data clusters. Examples of biases may be very implementation dependent and may span beyond the scope what is actually an explainable bias. Simple examples of biases include may include: efficient identification of people wearing glasses, misidentification of people based on poor representation of various demographics, misidentification of humans with colorful backgrounds, misidentification of humans moving faster than a certain speed, misidentification of humans wearing particular types of clothing, and/or other scenarios.

Biases may be created, reduced, or enhanced. And in the case of multiple biases, multiple biases may be created, reduced, or enhanced, where each bias may be treated distinct from all others.

Biases may be incorporated through labeling (also referred to as flagging) of the bias assessment. Labelling may be automated as part of the implementation and/or may include receiving user input. Labelling may be done through a computer interface, potentially sending segments of output to user labeling tools.

In some variations, a user and/or automated system may add biases to a bias assessment that had no bias, or some other bias. For example, a human recognition machine may have learned, from the used dataset, to identify an object with an inappropriate label. (e.g., labeling a pedestrian as a fire hydrant) In this example, a user may incorporate bias assessment to appropriately label such scenarios so as to removes all racist terminology, thereby preventing any associations to be made with racist terms.

In another example, the human recognition machine may show a bias of not recognizing humans that are sitting in a wheelchair (i.e., a false negative). In this example, a user may flag this bias as an undesired false negative. In a third example, the human recognition machine may occasionally recognize a plate as the face of a person. In this example, a user may flag this undesired bias as a false positive. This flagging or annotating could occur as a result of human review and supply of input through a provided user interface. The flagging could occur automatically through analysis of differences between expected results in test data and the output of the first learning model (e.g., seeing a cluster with high rates of false positive or false negative results).

In another version, a first learning model may output classification results that are problematic or undesired. For example, racist or offensive classifications could be learned from a large language model. A bias assessment for a cluster of similar scenarios resulting in such undesired could have a bias assessment applied to correct for such undesired classifications. In some variations, such groups or types of classifications could configured such that these clusters could be automatically or semi-automatically identified and/or corrected. In this way an interpretation of possible outputs of the supervised learning model may be used to identify problematic clusters and resolve these issues.

Determining bias assessments may be performed through receiving human-assisted input for one or more clusters. In this variation, the unsupervised learning process can facilitate grouping data with similar patterns. A user could review all or select clusters, and apply bias assessments. In some variations, clusters showing signs of being associated with false positives, false negatives, or a mixture of results may be prioritized for review. In addition to or as an alternative to manual review, collected feedback on performance of the learning model could also be used. For example, if a user or agent flags a particular example as being wrong, then this may trigger evaluation or assignment of a bias assessment for examples in a related cluster. Human-assisted input may be facilitated through a programmatic interface to the learning processing pipeline. For example, a user could use a command line prompt or programmatic framework to update the machine learning system. Human-assisted input may alternatively be facilitated through a user interface. For example, examples from a cluster could be presented and then various actions could be taken on that cluster.

Determining bias assessments may alternatively or additionally be performed through automated processes. In one automated process, false positive rates, false negative rates, or scenarios of unsatisfactory performance results could trigger the flagging of related data examples. A classifier could be trained to find similar scenarios to automate the discovery of suitable data examples. Inconsistencies or errors within any given cluster can indicate a need for more targeted training. The method could can then automatically sift through large quantities of unlabeled data in order to find examples that would become a part of the problematic cluster. Those examples can then be human labeled and used as future training data.

In some instances, an automated system may be used in flagging clusters where more training is desirable. In general, across all data and scenarios there will be some cases where the first learning model is well trained within a cluster and other clusters where the first learning model is not as well trained.

Identification, scoring, and/or labeling of such clusters may be useful in inspecting usage of a learning model and guiding subsequent improvements. In some cases, the system-level AUC is a weighted average of the cluster-level AUCs that make up the test data. As one potential benefit, targeting the worst-performing clusters for improvement is likely to improve the system-level performance, and remedy edge case problems, better than simply adding more bulk data that is untargeted to a known need.

Clusters may be further analyzed and/or annotated/labeled according to patterns of performance of the first model. When the refinement data has labeled expected results, clusters may be analyzed as correlating with correct results (e.g., true positives and/or true negatives, incorrect results (e.g., false positives and false negatives), and/or a mixture of true and false results.

Clusters of true positives and/or true negatives can indicate that the model is well-trained on these clusters of cases. In this way, the training data is sufficient for these scenarios, and no action is needed to inject bias or correct for any bias.

Clusters of false positives and false negatives can indicate that the model is anti-trained on these clusters of cases. The bias assessment generated in S140 can result in appropriate correction. This correction can include updating labels correctly and/or using additional data to retrain.

Clusters with a blend of true and false results can indicate that the model is insufficiently-trained on these clusters of cases. Corrective action in response to such a bias assessment can similarly include updating labels correctly and/or using as additional data to retrain. Adding more training data of similar cases may also be used. If more data is not available, then the method may include using these cases to train a side model to find more examples, and then use those discovered examples in subsequent training data.

In some variations, the method may use a hybrid of automating determining bias assessments and receiving human-assisted input in determining bias assessments.

In some variations, the volume of training data corresponding to a cluster may also be used in setting a bias assessment for a cluster. As discussed, in some variations, the first dataset may be analyzed using the unsupervised learning model to see how the training data maps to the clusters. Ideally, each well trained cluster will have a number of samples satisfying some sample volume condition (e.g., based on number of samples, variety of samples, diversity of samples, types of samples, etc.). Clusters that don't satisfy a sample volume condition may be flagged as include a sampling bias based simply on the fact that the supplied testing data is no sufficient for reliable training within that cluster. This bias assessment resulting from bad training data may happen to clusters with accurate results and/or inaccurate results. For example, if CV person detection model is trained with training data with only a single image of a person in a wheelchair, then that cluster may be flagged as being biased regardless of if the CV person detection model correctly or incorrectly detected the person in that single image. More representative sample data would make the resulting CV person detection model more robust.

Block S150, which includes training, using a third dataset, a bias assessment modified model using supervised learning, functions to train a learning model with the incorporation of the bias assessment. Dependent on implementation, and the desired biases (e.g., added, enhanced, reduced) may be incorporated as rules in the learning model or in the third dataset.

For example, if the process determines that the bias assessment, is due to insufficient data to learn from in the bias region, the third dataset may be modified to focus on that region. Dependent on implementation, this may include providing a message for the user to provide more appropriate for training (e.g., more pictures of people in wheelchairs to train from). In another variation, simulated data may be incorporated to provide the necessary data to learn from. In another variation, targeted data can be collected, labeled, and/or otherwise supplied to better train for one or more clusters to augment the bias assessment. This can result in better performance within that cluster

In some variations, the bias assessment may include rules to be incorporated into the learning model. That is, certain responses may be weighted as more, or less, favorable responses to increase or decrease the response. These variations may be more common when the model has learned “correctly”, but does not behave in a desired way.

In some variations, the result of the bias assessment may be used in cleaning or improving the original training data, as such this updated training data may be used directly in producing a retrained supervised learning model (without at least a portion of incorrectly labeled data).

The method may additionally use automated processes for augmenting training data for an updated learning model trained through block S150. In some variations, the method may include synthesizing data samples based on samples of the problematic cluster. This can include using the set of data samples from a cluster, to artificially generate new training data. This may use a diffusion model, a GAN (Generative Adversarial Networks), or other sample generating processes to create a diversity of samples.

In a similar manner, a process may be trained on samples in the cluster to facilitate detecting a data sample corresponding to the cluster (e.g., training a cluster detector), and then search for additional data samples using the trained cluster detector.

In other variations, a cluster may be flagged using an automated alert, requesting additional data for training. When automating this process of collecting data to augment the training data for a supervised learning model, the method may include various user interface features. In one variation, the method may include collecting supplemental data sample for the problematic cluster and verifying the supplemental data sample is matched to the problematic cluster using the second learning model. Additionally, the method may automatically set a target number of additional samples for collection and present a progress indicator based on the number of samples collected that match the problematic cluster. For example, if the problematic cluster involves users with wheelchairs, then a user may need to upload more sample data. A progress bar will progress towards a completion state as additional sample data is added that is classified within the same cluster (according to the unsupervised learning model).

It should be noted that block S150 is somewhat analogous to block S110. That is, in many variations the third dataset may be a modified first dataset, and/or the bias assessment modified model is a modified first learning model (e.g., an updated base supervised learning model). For example, in the example where humans in wheelchairs have been modeled with an undesired bias, the third dataset may include supplemental labeled data that contains more pictures of people in wheelchairs such that the bias assessment modified model may be more accurately process image data with wheelchairs.

As the method may be implemented as an iterative process, the method may cycle through and block S120 may be called again to determine (and/or measure old) biases in the learning model. In this manner, the method may cycle indefinitely between supervised and unsupervised learning, first to learn how to accomplish a certain task, and then to identify and determine the biases incorporated through the learning process.

### 3. System

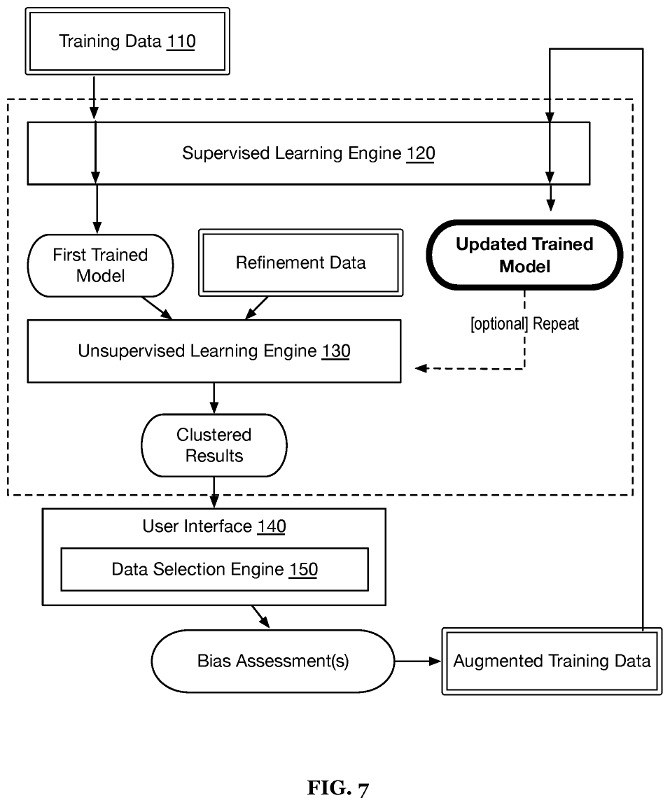

As shown in FIG. 7, a machine learning system may include: an initial set of training data 110; a processor or computer-implemented system, that includes: a supervised learning model (SLM) engine 120 and an unsupervised learning model (ULM) engine 130. The system may additionally include a user interface 140 that connects to the processor and enables interaction with the SLM and ULM learning model through a data selection engine 150. The system functions as a processor-based learning system that leverages the SLM engine 120 and the ULM engine 130 to learn an analysis model set out on the initial set of training data.

The system may function with the method described above but may generally be implemented with any learning method that includes sufficient memory capacity to achieve the level of desired learning. In addition to the aforementioned system components, the system may further include any additional components necessary to receive the necessary external input and any additional components necessary to for the system to provide the necessary external output. These additional system components may include any, and all, combinations of sensors and actuators necessary for the function of the machine. Examples of sensor/input devices include video camera (e.g., for image detection), microphone (e.g., for sound analysis), pressure sensors, thermometers, gyroscope, etc. Examples of actuators/output devices include: projectors, loud speakers, haptic feedback devices, and/or other types of devices.

The system may include an initial set of training data 110. The initial set of training data 110 functions to provide dedicated information to learn a task through supervised learning. In some variations, the initial set of training data 110 may include both input data and corresponding desired output data or be otherwise labeled data. In some variations, the initial dataset is not a part of the system, but is obtained prior, or during, implementation of the system.

The system may include one or more processors or computer-implemented systems. The processor system may function as the primary logic component that engages in machine learning. The processor may also be an interface to a processing service such as a cloud compute service or system used to remotely process data. Although referred to as a single processor, the processor may be multiple processors (e.g., as a cloud service or a network of processors/computers). As part of operation, the processor system may include supervised learning model (SLM) engine, and an unsupervised learning (ULM) engine. The SLM engine 120 and ULM engine 130 may be parts of the processor that are statically allocated for the mentioned single function (i.e., a part of the processor is allocated to just function as an SLM engine 120 and/or ULM engine 130 and do nothing else) or may be a dynamic processor allocation only during supervised learning and/or unsupervised learning.

The SLM engine 120 may be a component of the processor. The SLM engine 120 may be a statically allocated portion of the processor used just for supervised learning. Alternatively, the SLM engine 120 may be a dynamically allocated portion of the processor; wherein the amount of processing power allocated to the SLM engine 120 may be dynamically updated during supervised learning. The SLM engine 120 functions to process the initial set of data training in supervised learning, wherein the SLM engine 120 develops an operation algorithm (i.e., SLM) in response to the initial set of training data 110. Additionally, the SLM engine 120 functions to process all other supervised training data 110.

The ULM engine 130 may be a component of the processor. The ULM engine 130 may be a statically allocated portion of the processor used just for supervised learning. Alternatively, the ULM engine 130 may be a dynamically allocated portion of the processor; wherein the amount of processing power allocated to the ULM engine 130 may be dynamically updated during unsupervised learning. The ULM engine 130 functions to process the output of the SLM (i.e., unsupervised learning training data), wherein the ULM engine 130 organizes/clusters the output. These clusters may then be identified and labeled as biases.

The system may additionally include an interface. The interface may enable user interaction with the processor, and particularly interaction with biases. The interface may be any type of general computer interface (e.g., smart phone, personal computer, etc.). Through the data selection engine, a user may modify the current SLM, ULM, and training data 110. In some variations, the interface may include a data selection engine. The data selection engine functions to enable analysis and editing of labeled biases. The DSE may be particularly useful for inputting and editing training data 110. The user interface may be used to label or annotate one or more clusters. The type and form of user interface may be implemented in a variety of ways. In some variations, the user interface may provide a way of observing the different clusters for a model. In another variation, the user interface may enable inspection of one particular cluster. For example, a sample of images within a cluster and the corresponding output of the learning model may be reviewed and optionally corrected as in the exemplary screenshot of FIG. 6. In one variation, a user feedback system may be used to note data samples that have been flagged as problematic, and this user feedback may be used to automate detecting clusters with potential issues.

In another variation, an automated cluster analysis engine may facilitate automated processing of the clustered results from the ULM engine 130. The automated cluster analysis engine may facilitate automatically determining clusters with potential issues and/or taking corrective action to enhance performance for one or more clusters.

### 4. System Architecture

The systems and methods of the embodiments can be embodied and/or implemented at least in part as a machine configured to receive a computer-readable medium storing computer-readable instructions. The instructions can be executed by computer-executable components integrated with the application, applet, host, server, network, website, communication service, communication interface, hardware/firmware/software elements of a user computer or mobile device, wristband, smartphone, or any suitable combination thereof. Other systems and methods of the embodiment can be embodied and/or implemented at least in part as a machine configured to receive a computer-readable medium storing computer-readable instructions. The instructions can be executed by computer-executable components integrated with apparatuses and networks of the type described above. The computer-readable medium can be stored on any suitable computer readable media such as RAMs, ROMs, flash memory, EEPROMs, optical devices (CD or DVD), hard drives, floppy drives, or any suitable device. The computer-executable component can be a processor but any suitable dedicated hardware device can (alternatively or additionally) execute the instructions.

In one variation, a system comprising of one or more computer-readable mediums (e.g., non-transitory computer-readable mediums) storing instructions that, when executed by the one or more computer processors, cause a computing platform to perform operations comprising those of the system or method described herein such as: training, using a supervised learning process, a first learning model with a first dataset; applying the first learning model to a second dataset thereby generating a first learning model output; training, using an unsupervised learning process, a second learning model with the first learning model output thereby generating a clustering output of the second learning model; determining a bias assessment based on the clustering output; and training, using a third dataset, a bias assessment modified learning model using supervised learning.

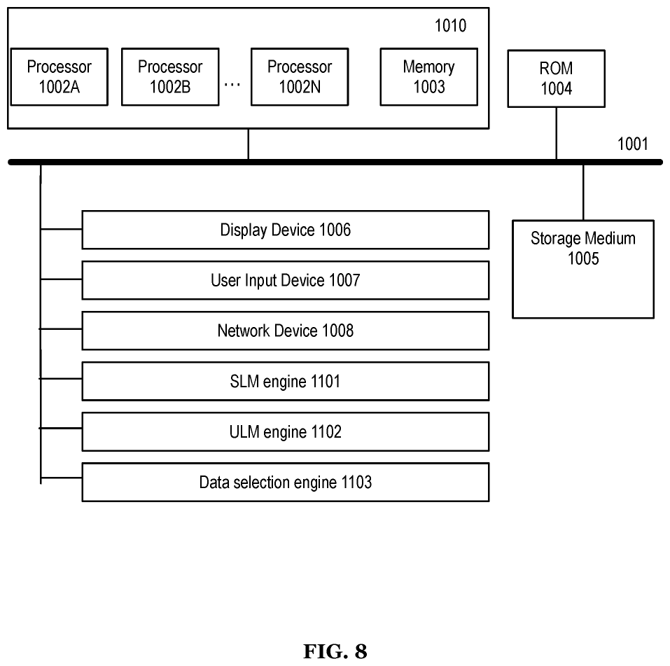

FIG. 8 is an exemplary computer architecture diagram of one implementation of the system. In some implementations, the system is implemented in a plurality of devices in communication over a communication channel and/or network. In some implementations, the elements of the system are implemented in separate computing devices. In some implementations, two or more of the system elements are implemented in same devices. The system and portions of the system may be integrated into a computing device or system that can serve as or within the system.

The communication channel 1001 interfaces with the processors 1002A-1002N, the memory (e.g., a random access memory (RAM)) 1003, a read only memory (ROM) 1004, a processor-readable storage medium 1005, a display device 1006, a user input device 1007, and a network device 1008. As shown, the computer infrastructure may be used in connecting a SLM engine 1101, ULM engine 1102, data selection engine 1103, and/or other suitable computing devices.

The processors 1002A-1002N may take many forms, such CPUs (Central Processing Units), GPUs (Graphical Processing Units), microprocessors, ML/DL (Machine Learning/Deep Learning) processing units such as a Tensor Processing Unit, FPGA (Field Programmable Gate Arrays, custom processors, and/or any suitable type of processor.

The processors 1002A-1002N and the main memory 1003 (or some sub-combination) can form a processing unit 1010. In some embodiments, the processing unit includes one or more processors communicatively coupled to one or more of a RAM, ROM, and machine-readable storage medium; the one or more processors of the processing unit receive instructions stored by the one or more of a RAM, ROM, and machine-readable storage medium via a bus; and the one or more processors execute the received instructions. In some embodiments, the processing unit is an ASIC (Application-Specific Integrated Circuit). In some embodiments, the processing unit is a SoC (System-on-Chip). In some embodiments, the processing unit includes one or more of the elements of the system.

A network device 1008 may provide one or more wired or wireless interfaces for exchanging data and commands between the system and/or other devices, such as devices of external systems. Such wired and wireless interfaces include, for example, a universal serial bus (USB) interface, Bluetooth interface, Wi-Fi interface, Ethernet interface, near field communication (NFC) interface, and the like.

Computer and/or Machine-readable executable instructions comprising of configuration for software programs (such as an operating system, application programs, and device drivers) can be stored in the memory 1003 from the processor-readable storage medium 1005, the ROM 1004 or any other data storage system.

When executed by one or more computer processors, the respective machine-executable instructions may be accessed by at least one of processors 1002A-1002N (of a processing unit 1010) via the communication channel 1001, and then executed by at least one of processors 1001A-1001N. Data, databases, data records or other stored forms data created or used by the software programs can also be stored in the memory 1003, and such data is accessed by at least one of processors 1002A-1002N during execution of the machine-executable instructions of the software programs.

The processor-readable storage medium 1005 is one of (or a combination of two or more of) a hard drive, a flash drive, a DVD, a CD, an optical disk, a floppy disk, a flash storage, a solid state drive, a ROM, an EEPROM, an electronic circuit, a semiconductor memory device, and the like. The processor-readable storage medium 1005 can include an operating system, software programs, device drivers, and/or other suitable sub-systems or software.

As used herein, first, second, third, etc. are used to characterize and distinguish various elements, components, regions, layers and/or sections. These elements, components, regions, layers and/or sections should not be limited by these terms. Use of numerical terms may be used to distinguish one element, component, region, layer and/or section from another element, component, region, layer and/or section. Use of such numerical terms does not imply a sequence or order unless clearly indicated by the context. Such numerical references may be used interchangeable without departing from the teaching of the embodiments and variations herein.

As a person skilled in the art will recognize from the previous detailed description and from the figures and claims, modifications and changes can be made to the embodiments of the invention without departing from the scope of this invention as defined in the following claims.

We claim:

1. A method comprising:
training, using a supervised learning process, a first learning model with a first dataset;
applying the first learning model to a second dataset thereby generating a first learning model output;
training, using an unsupervised learning process, a second learning model with the first learning model output thereby generating a clustering output of the second learning model; and
determining a bias assessment based on the clustering output.

2. The method of claim 1, further comprising training, using a third dataset, a bias assessment modified learning model using supervised learning.

3. The method of claim 2, wherein the third dataset is the first dataset modified based on the bias assessment.

4. The method of claim 1, further comprising:
determining a third dataset based in part on the bias assessment;
training, using the third data set, a bias assessment modified learning model using supervised learning;
applying the bias assessment modified learning model to the second dataset thereby generating a third learning model output;
training, using the unsupervised learning process, a fourth learning model with the third learning model output thereby generating a second clustering output of the fourth learning model;
determining a second bias assessment based on the second clustering output; and
training, using a fourth dataset, a second bias assessment modified learning model using supervised learning process.

5. The method of claim 2, wherein determining a bias assessment based on the clustering output comprises automatically determining a problematic cluster where the first model output matches an undesired condition.

6. The method of claim 5, further comprising synthesizing data samples based on samples of the problematic cluster.

7. The method of claim 2, comprising receiving, through an interface, bias assessments for a first cluster.

8. The method of claim 7, wherein receiving, through an interface, bias assessments for a first cluster comprises presenting a user interface with representative examples from at least one cluster; and receiving a bias assessment input for the at least one cluster.

9. The method of claim 1, wherein the first dataset and the second dataset include image data.

10. A non-transitory computer-readable medium storing instructions that, when executed by one or more computer processors of a computing platform, cause the computing platform to perform operations comprising:
training, using a supervised learning process, a first learning model with a first dataset;
applying the first learning model to a second dataset thereby generating a first learning model output;
training, using an unsupervised learning process, a second learning model with the first learning model output thereby generating a clustering output of the second learning model; and
determining a bias assessment based on the clustering output.

11. The non-transitory computer-readable medium of claim 10, further comprising training, using a third dataset, a bias assessment modified learning model using supervised learning.

12. The non-transitory computer-readable medium of claim 11, wherein the third dataset is the first dataset modified based on the bias assessment.

13. The non-transitory computer-readable medium of claim 11, wherein determining a bias assessment based on the clustering output comprises automatically determining a problematic cluster where the first model output matches an undesired condition.

14. The non-transitory computer-readable medium of claim 11, comprising receiving, through an interface, bias assessments for a first cluster.

15. A system comprising of:
one or more computer-readable mediums storing instructions that, when executed by the one or more computer processors, cause a computing platform to perform operations comprising:
training, using a supervised learning process, a first learning model with a first dataset;
applying the first learning model to a second dataset thereby generating a first learning model output;
training, using an unsupervised learning process, a second learning model with the first learning model output thereby generating a clustering output of the second learning model; and
determining a bias assessment based on the clustering output.

16. The system of claim 5, further comprising training, using a third dataset, a bias assessment modified learning model using supervised learning.

17. The system of claim 16, wherein the third dataset is the first dataset modified based on the bias assessment.

18. The system of claim 16, wherein determining a bias assessment based on the clustering output comprises automatically determining a problematic cluster where the first model output matches an undesired condition.

19. The system of claim 16, comprising receiving, through an interface, bias assessments for a first cluster.
